(19) United States
(12) Patent Application Publication
(10) Pub. No.: US 2008/0172686 A1
(43) Pub. Date: Jul. 17, 2008

(54) Method for Uniquely Identifying Optical Media

(76) Inventor: Richard H. Selinfreund, Clinton, CT (US)

Correspondence Address: KELLEY DRYE & WARREN LLP, 400 ALTLANTIC STREET , 13TH FLOOR, STAMFORD, CT, 06901, US

(21) Appl. No.: 11/949,401

(22) Filed: Dec. 3, 2007

Related U.S. Application Data
(60) Provisional application No. 60/885,199, filed on Jan. 16, 2007.

(51) Int. Cl. G11B 7/24

(52) U.S. Cl. 720/718

(57) ABSTRACT

A method for recording a unique identifier onto an optical medium said method comprising the stops of obtaining a manufactured optical medium and ink jet printing onto the read-side surface of said medium one or more light-changeable state change material(s) in a pattern, quantity, or combination which is uniquely different from another of the same type of optical medium, said light-changeable state change material being activatable between at least a first optical state to a second optical state by the read beam of an optical reader, the activation of which is detectable using the read beam of an optical reader for said optical medium.

### CROSS-REFERENCE TO RELATED APPLICATIONS

This application claims priority to U.S. Provisional Application No. 60/885,199, filed Jan. 16, 2007, the disclosure of which is incorporated by reference herein in its entirety to the extent not contrary to the present disclosure.

### BACKGROUND OF THE INVENTION

A method for serializing optical media without need for laser inscription of unique identifying indicia into the medium. Such serialization may be by way of uniquely marking each media with optically detectable material or physical perturbations. Serialization marking may be on the laser incident side of the optical medium, with the material or physical perturbations being readable at the read laser wavelengths of an optical reader. Material, such as light-changeable dye, may be applied to a medium by means of ink jet or other printing techniques.

### DESCRIPTION OF THE RELATED ART

Postscribed ID™ (PID) is a technology from Sony that enables the additional inscription of a unique ID onto a CD-ROM's signal face after the disc molding process at the disc plant. This provides customers with a convenient way to produce individually identifiable discs, allowing access only to those customers who own a legally produced disc. PID can replace the PC software disc key, such as a serial number that has to be input manually from the keyboard when installing the software. By using a high-power laser diode, a new reflective layer material, and extremely accurate location control technology, Postscribed ID™ can enable CD-ROM publishers to identify each disc of an individual title. “Postscribed ID™” technology enables disc customers to inscribe personal data such as serial number and data freely defined by them. When the disc content is encrypted, Postscribed ID™ provides a convenient way of establishing the identity of the disc user in decryption key distribution. Include an authentication key code and locked content on each disc with Postscribed ID™ technology. The unlocking key will be delivered when user sends authentication key code online.

While PID technology provides advantages, the fact that such technique requires laser inscription apparatuses to be included in the manufacturing lines may add unacceptable capital cost to the production of discs, as well as reducing manufacturing speed to unacceptable levels.

Other companies, such as Uniloc, have proposed a software method by which the read of each manufactured disc can be used to distinguished the disc from other manufactured discs with respect to a reader on which they are read. Such system may require more than desired time in determining the uniqueness of a disc, and may require more data real estate than desired.

Discs have also been made unique by including serial numbers to either the data recorded on the disc or to the disc itself. Such disc serialization allows each disc to be unique, but does not work to prevent easy obscuring of the serial number or removal of the same from the software code in the production of an illicit copy.

Current technology provides for use of a disc that is secured by a personal identity code or password. Techniques are known for checking a disc for authenticity and allowing play upon discernment of authenticity. For example, Sony Secure Rom allows an .exe to run if a disc contains code indicative of authenticity. The .exe run may allow access to content on an exclusive website, such as, for example, through a Secure Web Link.

An improved method for manufacturing unique optical discs is needed.

### DEFINITIONS

“Digital Datum Indicia”: an indicium or indicia on a Digital Recording Medium corresponding to a digital data read. Such indicia include optical pits and lands on an optical recording medium, electromagnetically altered portions on a floppy drive, recording dyes altered for digital read, punctuate indicia representative of a digital data read.

“Digital Reader”: any device capable of detecting and reading digital information that has been recorded on a Digital Recording Medium. By the term “reader” it is meant to include, without limitation, a player. Examples are CD and DVD readers.

“Digital Recording Medium”: a medium of any geometric shape (not necessarily circular) that is capable of storing information in digital form thereon. Digital recording medium includes, without limitation, CD, DVDs, HD-DVDs, electromagnetic tape and disks, flash drives and Optical Medium. Information stored on the medium may include, without limitation, software programs, software data, sensory files, audio files and video files.

“Light-Activated State-Change Material”: a State-Change Material that alters a measurable parameter upon application of a wavelength, or subwavelength, of light or application of photonic energy to the material.

“Optical Medium”: a medium of any geometric shape (not necessarily circular) that is capable of storing indicia or content that may be read by an optical reader.

“Optical Reader”: a Reader (as defined below) for the reading of Optical Medium.

“Permanent State-Change Material”: a State-Change Material that once activated to change a measurable parameter upon application of energy to the material, stays in such state permanently or for a prolonged period of time.

“State-Change Material”: a material capable of altering a measurable property of the material upon activation of the material by application of energy to the material. By “state change material” it is meant to include, without limitation, materials that change in optical state (e.g., opacity and/or color) upon application of energy to the materials, materials that change in electromagnetic state (e.g., electroconductive state) upon application of energy to the materials, and materials that change in physical state (e.g. crystalline to non-crystalline structure, materials that shrink upon application of heat) upon application of energy to the material.

“Temporary State-Change Material”: a State-Change Material that, once activated to change a measurable property of the material upon application of energy to the material, stays in such state for a period of time less than a year.

“Transient State-Change Material”: a State-Change material that, once activated to change a measurable property of the material, spontaneously in a short period of time (minutes or less), loses such change in the measurable property. It includes, without limitation, materials that move from a first state to a second state upon application of energy, and back to the first state without application energy.

“Transportable Recording Medium”: a relatively small medium capable of being transported by hand from one location to another. It includes, without limitation, Transportable Digital Recording Medium such as an optical disc, a floppy disk, or a flash drive.

For the purpose of the rest of the disclosure, it is understood that the terms as defined above are intended, whether such terms are in initial cap or not.

### SUMMARY OF THE INVENTION

There is described herein in embodiments, a uniquely identified optical medium comprising light-activated state change material uniquely associated with said optical medium, said light-activated state change material being readable by an optical reader at the wavelengths of the reader, and being decipherable by software and/or hardware as a unique marker. In such embodiment, the light-activated state change material may be a material that changes optical state upon application of a wavelength characteristic of the read beam of an optical reader. Such materials may be, for example, a transient state material, a temporary or permanent state-change material. The optical medium may be a digital recording medium, such as a transportable recording medium, comprised of a plurality of digital datum indicia.

Also disclosed is a method for recording a unique identifier onto an optical medium said method comprising the steps of: obtaining a manufactured optical medium; and ink jet printing onto the read-side surface of said medium one or more light-changeable state change material(s) in a pattern, quantity, or combination which is uniquely different from another of the same type of optical medium, said light-changeable state change material being activatable between at least a first optical state to a second optical state by the read beam of an optical reader, the activation of which is detectable using the read beam of an optical reader for said optical medium.

Further disclosed is a method for determining whether an optical medium is a medium authorized to access data, said method comprising: determining a unique identifier on the read-side surface of said optical medium based on detection of optical state changes on the surface of the optical medium by the read beam of an optical reader; comparing the unique identifier with those identifiers previously determined to have authorized access data; and allowing access to said data only if said unique identifier correlates with an identifier previously determined to have authorized access to the data.

These and further embodiments are disclosed in the detailed description below.

### BRIEF DESCRIPTION OF THE DRAWINGS

FIG. 1 illustrates an exemplary optical medium wherein a light-changeable state change material is applied to the laser read-side of the optical medium in a line.

### DETAILED DESCRIPTION OF THE INVENTION

In embodiments, there is provided a secured disc that is pre-coded with a unique identifier and which allows access to an executable only upon discernment of the unique identifier. By wrapping the executable with the unique identifier, the disc is protected against copying, that is copied discs will not be authenticated and the executable will not run. The executable may allow access to a secure web site.

In one embodiment, serialization occurs by marking each optical medial with a digital certificate of uniqueness defined by material or non-nominal indicia associated with a manufactured medium. In an aspect of such embodiment, a material is printed onto the medium after its production to produce a unique identifier that is capable of being optically read by an optical reader. The printing of the material may be on the laser incident side of the medium, to allow read by the standard read beam of an optical reader. In a particular aspect, the material which is printed is a light-changeable dye, and the light change or characteristic of the light-changeable dye system (for example, measurement of the time of change between one state and another state, a determination of a different data read to a change between states and an association of the material in manner to cause a different data read depending on optical state) is used to determine whether a medium is authenticated for read. The material may be printed on each medium differently, and/or different types of materials may be printed on a medium, to allow for unique medium with respect to measured parameter(s). Using such printing technique, on can reach speeds of manufacture of unique media that far exceeds that capable of being produced by laser inscription. Printing may be way of any printing technique, for example CIJ printing methods.

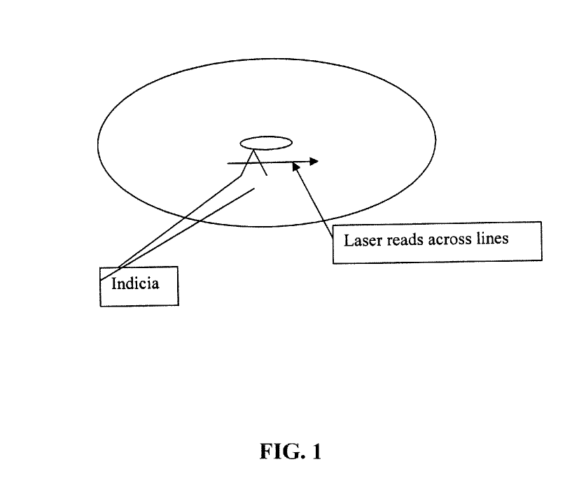

In another embodiment, dye is used to individually mark each piece of optical media. The marks on each medium may comprise any number of configurations as long as in totality they result in a uniquely identifiable medium. For example, the marks may comprise simple bars, forming for example a bar code, or may consist of complex binary algorithms. The materials printed may be permanent state-change materials, transient state-change materials, or temporary state change materials. FIG. 1 shows an exemplary optical medium of the present invention wherein the material is printed on the laser read-side in a line.

In such embodiments, the marking or indicia can comprise any number of markings or indicia and may be added to the medium at any number of locations. In one embodiment, certain of the indicia is added to the lead-in region. The indicia may also be added to another region. Software instructions maybe used to proceed to the indicia to determine the serial number of the unique identifier of the medium. The indicia could also be added at multiple places on the read surface and reassembled during the read instructions to complete the serial code.

In an embodiment, high speed printing lines are used and the medium is serialized or uniquely marked after manufacture of the same. Printing may be without the requirement of a medium manufacturing operation or the requirement of media locking software.

What is claimed is:

1. A uniquely identified optical medium comprising light-activated state change material uniquely associated with said optical medium, said light-activated state change material being readable by an optical reader at the wavelengths of the reader, and being decipherable by software and/or hardware as a unique marker.

2. The medium of claim 1 wherein the light-activated state change material is a material that changes optical state upon application of a wavelength characteristic of the read beam of an optical reader.

3. The medium of claim 2 wherein the light-activated state change material is a transient state material.

4. The medium of claim 2 wherein the light-activated state change material is a temporary state material.

5. The medium of claim 2 wherein the light-activated state change material is a temporary state material.

6. The medium of claim 1 wherein the medium is a digital recording medium.

7. The medium of claim 6 wherein the medium records data in a digital datum indicia.

8. The medium of claim 1 wherein the medium is a transportable recording medium.

9. A method for recording a unique identifier onto an optical medium said method comprising the steps of:
obtaining a manufactured optical medium; and
ink jet printing onto the read-side surface of said medium on one or more light-changeable state change material(s) in a pattern, quantity, or combination which is uniquely different from another of the same type of optical medium, said light-changeable state change material being activatable between at least a first optical state to a second optical state by the read beam of an optical reader, the activation of which is detectable using the read beam of an optical reader for said optical medium.

10. A method for determining whether an optical medium is a medium authorized to access data, said method comprising:
determining a unique identifier on the read-side surface of said optical medium based on detection of optical state changes on the surface of the optical medium by the read beam of an optical reader;
comparing the unique identifier with those identifiers previously determined to have authorized access data; and
allowing access to said data only if said unique identifier correlates with an identifier previously determined to have authorized access to the data.
